(19) United States
(12) Patent Application Publication
(10) Pub. No.: US 2020/0300123 A1
(43) Pub. Date: Sep. 24, 2020

(54) TURBOCHARGER COMPRESSOR HOUSINGS

(71) Applicant: Ford Global Technologies, LLC, Dearborn, MI (US)

(72) Inventors: Carl Stephen Newman, Colchester (GB); Pierce O'Sullivan, Stratford (GB); Steve Johnson, Brentwood (GB); Ryan Wells, South Woodham Ferrers (GB); Sam Watton, Rochester (GB)

(21) Appl. No.: 16/823,204

(22) Filed: Mar. 18, 2020

(30) Foreign Application Priority Data
Mar. 21, 2019 (GB) 1903892.6

(51) Int. Cl. F01D 25/24; F02C 6/12; F02M 25/06

(52) U.S. Cl. CPC F01D 25/24; F02C 6/12; F05B 2220/40; F05D 2220/40; F02M 25/06

(57) ABSTRACT

Systems are provided for a crankcase ventilation duct. In one example, the crankcase ventilation duct is integrally formed with a compressor housing wherein surfaces of the compressor housing shape a passage of the crankcase ventilation duct.

### CROSS REFERENCE TO RELATED APPLICATION

The present application claims priority to Great Britain patent application No. 1903892.6, filed on Mar. 21, 2019. The entire contents of the above-listed application are hereby incorporated by reference for all purposes.

### FIELD

The present description relates generally to turbocharger compressor housing and is particularly, although not exclusively, concerned with a turbocharger compressor housing configured to reduce freezing of crankcase ventilation gases.

### BACKGROUND/SUMMARY

Engines, e.g. for motor vehicles, often comprise a crankcase ventilation system configured to extract gases, e.g. blow-by gases, from inside the crankcase. The gases that are extracted from the crankcase may be reintroduced into the intake system to be drawn back into the engine cylinders.

In cold ambient temperatures, water within the crankcase ventilation gases can begin to freeze at or close to the point at which they are reintroduced into the intake system. Freezing of the crankcase ventilation gases can block the crankcase ventilation system, leading to a build-up of blow-by gases within the crankcase, which is undesirable.

Previous examples include where a heater is configured to heat a crankcase ventilation duct to raise a temperature of crankcase ventilation gases and reduce a likelihood of water within the crankcase ventilation gases freezing. However, heaters may increase manufacturing costs while also decreasing fuel economy.

In one example, the issues described above may be addressed by a turbocharger compressor housing for a motor vehicle, the housing comprising a compressor housing portion for housing at least a portion of the turbocharger compressor, e.g. a rotor of the turbocharger compressor; a compressor inlet duct portion for carrying a flow of inlet gases to an inlet of the turbocharger compressor, and a crankcase ventilation pipe, e.g. a spigot for coupling a crankcase ventilation duct to the turbocharger compressor housing, in fluidic communication with the inlet of the turbocharger compressor, e.g. via the intake duct and/or the compressor housing portion, the pipe for the introduction of crankcase ventilation gases into the turbocharger compressor, wherein the pipe is integrally formed with the compressor housing portion.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows schematic view of a previously proposed engine assembly;

FIG. 2 shows a schematic view of an engine assembly according to arrangements of the present disclosure;

FIGS. 3a and 3b show perspective views of a turbocharger compressor according to arrangements of the present disclosure;

FIG. 4a shows a perspective view of a turbocharger compressor assembly according to another arrangement of the present disclosure;

FIG. 4b shows a schematic, cross-sectional view of the turbocharger compressor assembly shown in FIG. 4a;

FIG. 5a shows a perspective view of a turbocharger compressor assembly according to another arrangements of the present disclosure; and

FIG. 5b shows a schematic, cross-sectional view of a turbocharger compressor assembly shown in FIG. 5a.

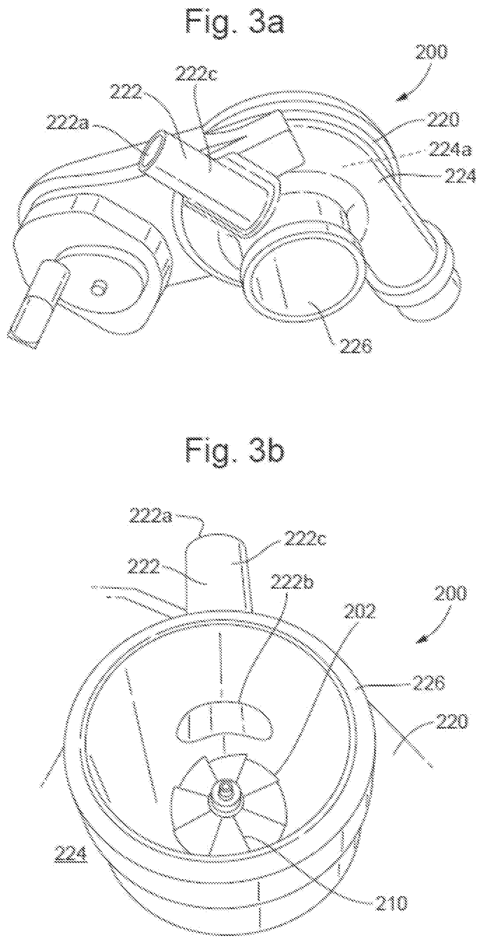

FIGS. 3a, 3b, 4a, and 5a are shown approximately to scale, however, other relative dimensions may be used if desired.

### DETAILED DESCRIPTION

The following description relates to systems and methods for a turbocharger compressor housing for a motor vehicle, the housing comprising a compressor housing portion for housing at least a portion of the turbocharger compressor, e.g. a rotor of the turbocharger compressor, a compressor inlet duct portion for carrying a flow of inlet gases to an inlet of the turbocharger compressor, and a crankcase ventilation pipe, e.g. a spigot for coupling a crankcase ventilation duct to the turbocharger compressor housing, in fluidic communication with the inlet of the turbocharger compressor, e.g. via the intake duct and/or the compressor housing portion, the pipe for the introduction of crankcase ventilation gases into the turbocharger compressor, wherein the pipe is integrally formed with the compressor housing portion.

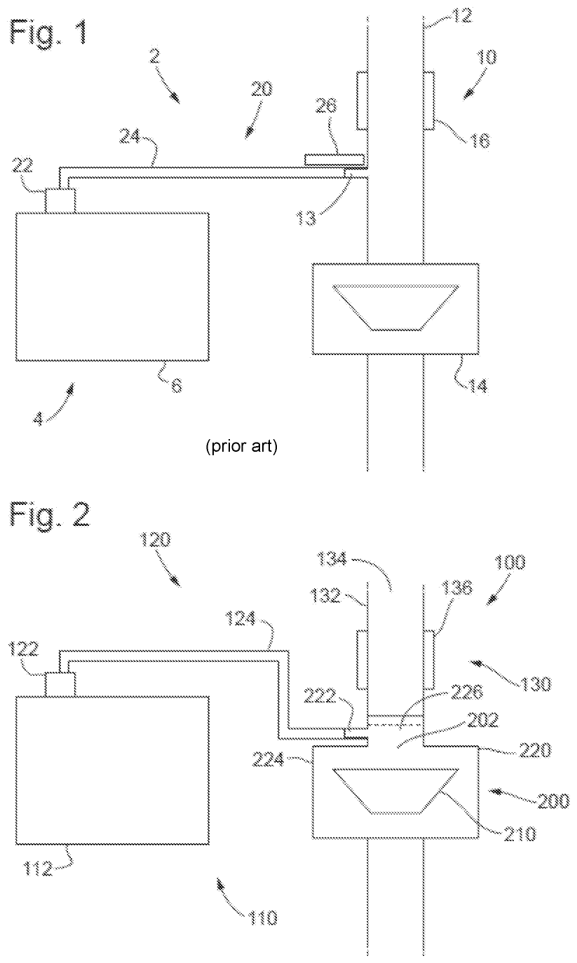

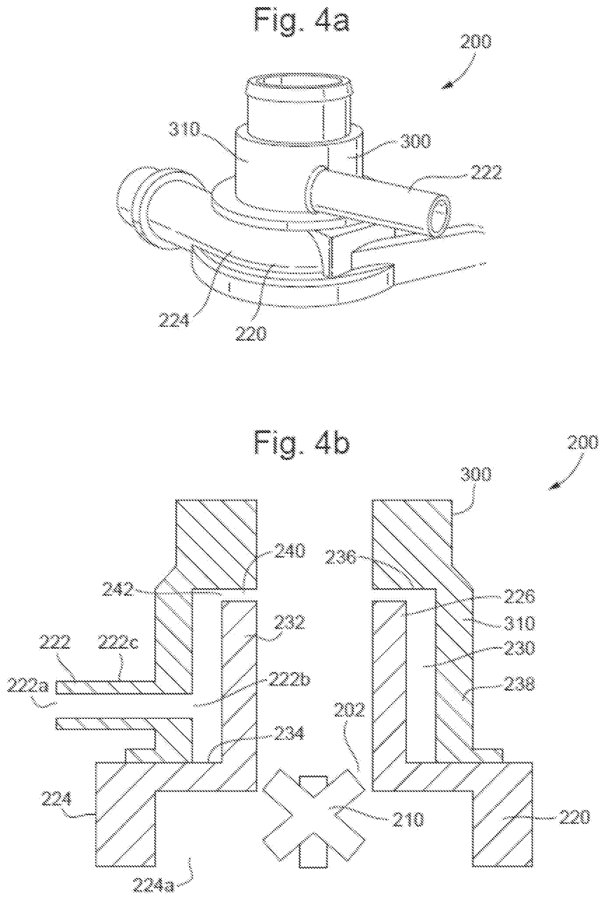

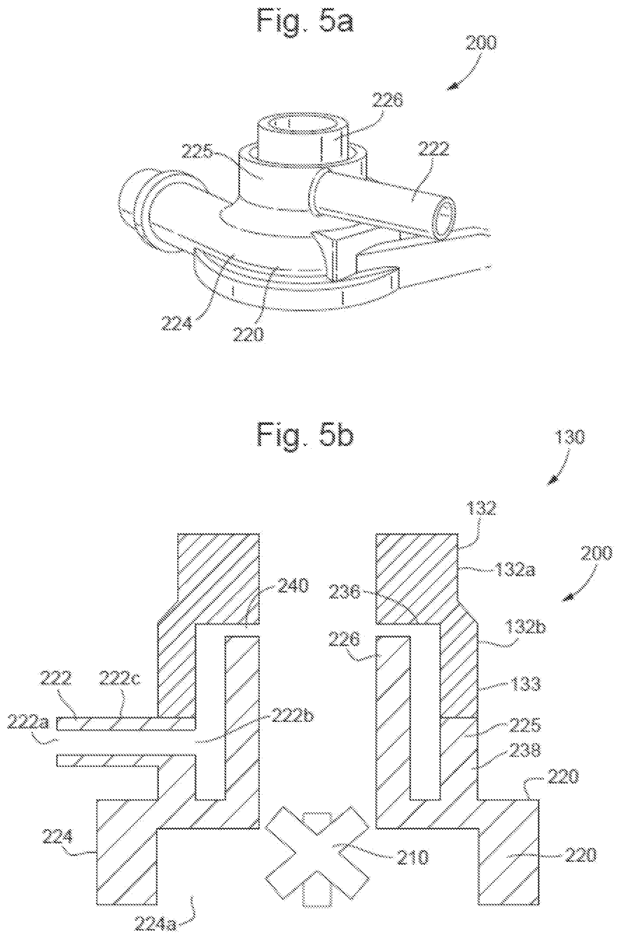

A prior art example illustrated in FIG. 1 shows a heater configured to heat crankcase ventilation gases to mitigate freezing of water therein. FIG. 2 shows a schematic view of an engine assembly according to arrangements of the present disclosure wherein a crankcase ventilation inlet chamber is integrally formed with a compressor inlet duct that that crankcase ventilation gases within the crankcase ventilation inlet chamber are in contact with the compressor intake duct. FIGS. 3a and 3b show perspective views of a turbocharger compressor according to arrangements of the present disclosure. FIG. 4a shows a perspective view of a turbocharger compressor assembly according to another arrangement of the present disclosure. FIG. 4b shows a schematic, cross-sectional view of the turbocharger compressor assembly shown in FIG. 4a. FIG. 5a shows a perspective view of a turbocharger compressor assembly according to another arrangements of the present disclosure. FIG. 5b shows a schematic, cross-sectional view of a turbocharger compressor assembly shown in FIG. 5a.

The compressor inlet duct portion may be integrally formed with the compressor housing portion. In other words, the compressor housing portion, compressor inlet duct portion, and the crankcase ventilation pipe may be a one-piece component. The turbocharger housing may be a one-piece metal component.

The pipe may comprise an inlet opening, an outlet opening, and a duct portion extending between the inlet opening and the outlet opening. The duct portion may be in contact with, or may be integrally formed with the compressor housing portion. In one example, the duct portion is in contact with a wall of the compressor housing portion.

The compressor housing portion may at least partially define an outlet volume, e.g. an outlet flow passage, of the turbocharger compressor, such as an outlet diffuser, volute or scroll.

The turbocharger compressor housing may further comprise a crankcase ventilation inlet chamber extending about the compressor intake duct. The crankcase ventilation inlet chamber may be in fluidic communication with the inlet of the turbocharger compressor. The pipe may be in fluidic communication with the crankcase ventilation inlet chamber, e.g. via the intake duct and/or the compressor housing portion. For example, a passage may be formed between the crankcase ventilation inlet chamber and the compressor inlet duct portion, e.g. in an inner wall of the chamber. The passage may be formed at an opposite end of the crankcase ventilation inlet chamber to an opening of the pipe into the crankcase ventilation inlet chamber.

At least a portion of a wall of the crankcase ventilation inlet chamber may be formed by the compressor inlet duct portion and/or the compressor housing portion, e.g. such that crankcase ventilation gases within the crankcase ventilation inlet chamber are in contact with the wall of the compressor intake duct and/or the compressor housing portion. For example, an inner wall, e.g. an inner radial wall, of the crankcase ventilation inlet chamber may be formed by a wall of the compressor inlet duct portion. An axial end wall and/or an outer, e.g. radially outer, wall of the crankcase ventilation inlet chamber may be at least partially formed by the compressor housing portion.

A passage is formed between the crankcase ventilation inlet chamber and the compressor intake duct or the compressor housing portion. An opening of the passage into the crankcase ventilation inlet chamber may be spaced apart from an opening of the pipe into the crankcase ventilation inlet chamber along a wall of the of the crankcase ventilation inlet chamber formed by the compressor intake duct and/or the compressor housing portion.

The turbocharger compressor housing may further comprise a wall portion extending at least partially about the controller intake duct. An outer, e.g. radially outer, wall of the crankcase ventilation inlet chamber may be at least partially formed by the wall portion. The wall portion may be integrally formed with the compressor housing portion.

The crankcase ventilation inlet chamber may be configured to damp pressure variations in the inlet air arriving at the compressor intake duct. For example, the volume of the crankcase ventilation inlet chamber may be tuned to act as an inlet resonator.

According to another aspect of the present disclosure, there is provided a turbocharger compressor housing, the housing comprising an intake duct portion for carrying a flow of inlet gases to an inlet of the turbocharger compressor, a chamber disposed about a portion of the housing, wherein the chamber is configured to damp pressure variations within the inlet gases, and a pipe coupled to the chamber for inducing gases separated from a crank case ventilation system into the inlet gases.

According to another aspect of the present disclosure, there is provided a turbocharger compressor housing for a motor vehicle, the housing comprising a compressor housing portion for housing at least a portion of the turbocharger compressor, a compressor inlet duct portion for carrying a flow of inlet gases to an inlet of the turbocharger compressor; and a crankcase ventilation pipe in fluidic communication with the inlet of the turbocharger compressor, the pipe for the introduction of crankcase ventilation gases into the turbocharger compressor.

An intake assembly may comprise the above mentioned turbocharger compressor housing and an intake duct in fluidic communication with the compressor intake duct.

A wall of the crankcase ventilation inlet chamber may be at least partially formed by the intake duct. For example, an axial end wall of the crankcase ventilation inlet chamber may be at least partially formed by the intake duct. The intake duct may comprise a duct portion and a connector coupled to or integrally formed with the duct portion. The wall of the crankcase ventilation inlet chamber may be at least partially formed by the connector of the intake duct. At least a portion of an outer wall of the crankcase ventilation inlet chamber may be formed by the intake duct, e.g. a radially outer wall.

A motor vehicle may comprise the above-mentioned turbocharger compressor housing or the above-mentioned intake assembly.

FIGS. 1-5b show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example. It will be appreciated that one or more components referred to as being “substantially similar and/or identical” differ from one another according to manufacturing tolerances (e.g., within 1-5% deviation).

With reference to FIG. 1, a previously proposed engine assembly 2 comprises an engine 4 including a crankcase 6, and an intake system 10. The intake system comprises an intake duct 12, a turbocharger compressor 14, and an intake resonator 16 for damping vibrations of the inlet gases within the intake duct 12 at a desired frequency, e.g. at which it is desirable to reduce noise within the intake system.

The engine assembly 2 further comprises a crankcase ventilation system 20 comprising a crankcase ventilation valve 22 coupled to the crankcase 6, and a crankcase ventilation duct 24 for carrying extracted crankcase ventilation gases from the crankcase ventilation valve 22 to the intake duct 12. The pressure within the intake duct 12 may be less than the pressure within the crankcase 6, and hence, blow-by gases within the crankcase 6 may be drawn through the crankcase ventilation valve 22 and the crankcase ventilation duct 24 into the intake duct 12.

As shown in FIG. 1, the intake duct 12 comprises a spigot 13 formed on the intake duct. The crankcase ventilation duct 24 is fluidically coupled to the intake duct 12 at the spigot 13 and the crankcase ventilation gases are introduced into the intake duct 12 via the spigot 13.

In order to block the crankcase ventilation duct 24 from become blocked by ice forming in the crankcase ventilation duct 24, the crankcase ventilation system may further comprise a heater 26 configured to heat the crankcase ventilation duct 24 to raise the temperature of the crankcase ventilation gases and reduce the risk of water within the crankcase ventilation gases freezing.

With reference to FIG. 2, an engine assembly 100 for a motor vehicle is shown, according to arrangements of the present disclosure comprising an engine 110, a crankcase ventilation system 120, and an intake system 130.

The engine 110 is similar to the engine 4 and comprises a crankcase 112. The crankcase ventilation system 120 is similar to the crankcase ventilation system 20 and comprises a crankcase ventilation valve 122, in fluidic communication with the interior of the crankcase 112, and a ventilation duct 124 for carrying extracted crankcase ventilation gases from the valve 122 to be reintroduced into the intake system 130, as described below.

The intake system 130 comprises turbocharger compressor assembly 200 and an intake duct 132 for carrying intake gases from an air inlet 134 to an inlet 202 of a turbocharger compressor, e.g. a compressor rotor 210 of the turbocharger compressor assembly 200. The intake system 130 may further comprise an intake resonator 136 that is similar to the intake resonator 16 described above.

The turbocharger compressor assembly 200 comprises the turbocharger compressor, e.g. the compressor rotor 210, and a turbocharger compressor housing 220. The turbocharger compressor housing 220 defines the turbocharger compressor inlet 202 and is configured to house the compressor rotor 210.

In the arrangement shown in FIG. 2, the turbocharger compressor assembly is depicted as an axial flow machine. However, in other arrangements the turbocharger compressor may be a radial or mixed flow machine, e.g. an axial-to-radial flow machine, as depicted in FIG. 3a.

The intake system 130 differs from the intake system 10 depicted in FIG. 1 in that the intake resonator 136 does not comprise a spigot for introducing the crankcase ventilation gases into the intake system 130. Instead, a crankcase ventilation pipe, e.g. a crankcase ventilation spigot 222, is formed on the turbocharger compressor assembly 200 for the crankcase ventilation gases to be introduced into the intake system. As shown in FIG. 2, the crankcase ventilation spigot 222 is formed on the turbocharger compressor housing 220.

With reference to FIGS. 3a and 3b, the crankcase ventilation spigot 222 may be formed integrally with the turbocharger compressor housing 220. The turbocharger compressor housing comprises a compressor housing portion 224, configured to house at least a portion of the turbocharger compressor, e.g. the rotor 210 of the turbocharger compressor, and a compressor inlet duct portion 226 for carrying intake gases from the intake duct 132 to the inlet 202 of the turbocharger compressor.

The crankcase ventilation spigot 222 may be formed integrally with the compressor housing portion 224 and/or the compressor inlet duct portion 226. As depicted, the compressor housing portion 224, the compressor inlet duct portion 226, and the crankcase ventilation spigot 222 may be formed integrally with one another such that the turbocharger compressor housing 220 is a one-piece component. For example, the turbocharger compressor housing 220 may be a one-piece cast component.

The crankcase ventilation spigot 222 may be formed from the same material as the compressor housing portion 224, and/or the compressor inlet duct portion 226. In particular, the crankcase ventilation spigot 222 may be manufactured from a metal material. Accordingly, heat may be transferred from the compressor housing portion 224 to the crankcase ventilation spigot 222 through heat conduction more effectively than if the crankcase ventilation spigot 222 was manufactured from a different material. Furthermore, the proximity of the crankcase ventilation spigot 222 may further enhance heat conduction from the compressor housing portion 224 to the crankcase ventilation spigot 222 to decrease an amount and/or a likelihood of freezing.

The compressor housing portion 224 may at least partially define an outlet flow passage of the turbocharger compressor. For example, the compressor housing portion 224 may at least partially define an outlet volume 224a, e.g. a diffuser, volute or scroll of the turbocharger compressor. Gases within the outlet volume may have been heated by virtue of the action of the turbocharger compressor. The compressor housing portion 224 may be heated by the gases within the outlet volume 224a.

Referring for FIGS. 3a and 3b, the crankcase ventilation spigot 222 comprises an inlet opening 222a, for receiving the crankcase ventilation gases from the crankcase ventilation duct 124, an outlet opening 222b, though which the crankcase ventilation gases enter the compressor inlet duct portion 226 or compressor housing portion 224, and a duct portion 222c extending between the inlet and outlet openings 222a, 222b, respectively.

As shown in FIG. 3a, the crankcase ventilation spigot 222 may be arranged such that a wall of the duct portion 222c is in contact with or is integrally formed with the compressor housing portion 224. In particular, the wall of the duct portion 222c may be in contact with or integrally formed with a part of the compressor housing portion 224 forming a wall of the compressor outlet volume 224a.

With reference to FIG. 3b, the crankcase ventilation spigot 222 may be arranged such that the outlet opening 222b is adjacent, e.g. immediately adjacent, to the inlet 202 of the turbocharger compressor.

With reference to FIGS. 4a and 4b, in another arrangement of the present disclosure the turbocharger compressor assembly 200 may comprise a crankcase ventilation inlet chamber 230. The crankcase ventilation spigot 222 is in fluidic communication with the crankcase ventilation inlet chamber 230 and the crankcase ventilation gases are introduced into the crankcase ventilation inlet chamber 230 before flowing from the crankcase ventilation inlet chamber 230 into the compressor inlet duct portion 226 or compressor housing portion 224, e.g. via a passage 240 formed between the crankcase ventilation inlet chamber 230 and the compressor inlet duct portion 226 or compressor housing portion 224.

As shown, the crankcase ventilation inlet chamber 230 is arranged about the turbocharger compressor inlet 202. The crankcase ventilation inlet chamber 230 may be arranged about the compressor inlet duct portion 226. For example, the crankcase ventilation inlet chamber 30 may comprise a toroidal volume defined about an axis that is substantially aligned with a central axis of the turbocharger compressor inlet duct portion 226, e.g. the direction of the flow of inlet gases into the turbocharger compressor.

At least a portion of a wall forming the crankcase ventilation inlet chamber 230 may be formed by, or integrally formed with, the compressor inlet duct portion 226 and/or the compressor housing portion 224. For example, as shown in FIG. 4b, an inner, e.g. radially inner, wall 232 of the crankcase ventilation inlet chamber 230 may be formed by the compressor inlet duct portion 226. Additionally or alternatively, a first end wall 234, e.g. at a first axial end of the crankcase ventilation inlet chamber 230, may be formed by the compressor housing portion 224.

As described above, the compressor housing portion 224 may be heated by the gases within the outlet volume 224a of the compressor. The crankcase ventilation gases within the crankcase ventilation inlet chamber 230, which are in contact with the first end wall 234, may therefore be heated.

Additionally, the compressor inlet duct portion 226 is in thermal communication with the compressor housing portion 224 and is heated by the gases within the compressor outlet volume 224a through thermal conduction, e.g. via the material of the compressor housing portion 224. Accordingly, the crankcase ventilation gases within the crankcase ventilation inlet chamber 230, which are in contact with the inner wall 232, may be heated.

As shown in FIG. 4b, the outlet opening 222b of the crankcase ventilation spigot 222 may be positioned at a first end, e.g. axial end, of the crankcase ventilation inlet chamber 230, e.g. adjacent to the first end wall 234. An opening 242 of the passage 240 into the crankcase ventilation inlet chamber 230 may be spaced apart from outlet opening 222b along a length of a wall of the crankcase ventilation inlet chamber 230 formed by the compressor inlet duct portion 226 and/or the compressor housing portion 224. For example, the opening 242 may be formed adjacent to a second end wall 236 of the inlet chamber 230, e.g. at a second (axial) end of the crankcase ventilation inlet chamber 230. The crankcase ventilation gases may therefore flow over the length of wall before flowing through the passage 240 into the compressor inlet duct portion 226 or the compressor housing portion 224.

As shown in FIGS. 4a and 4b, the turbocharger assembly may comprise a chamber forming part 300. The chamber forming part 300 may be coupled to the compressor housing 220. The chamber forming part 300 may comprise a hollow substantially cylindrical portion 310 positioned about the intake duct portion 226 of the compressor housing 220 when the chamber forming part 300 is coupled to the compressor housing 220. An outer, e.g. radially outer, wall 238 of the inlet chamber 230 may be formed by the chamber forming part 300, e.g. by the hollow cylindrical portion 310.

The crankcase ventilation spigot 222 may be coupled to or formed integrally with the chamber forming part 300. The outlet opening 222b of the crankcase ventilation spigot may be formed in the cylindrical portion 310 of the chamber forming part, e.g. in the outer wall 238 of the crankcase ventilation inlet chamber 230.

In the arrangement shown in FIGS. 4a and 4b, the chamber forming part 300 is configured to form the second end wall 236 of the crankcase ventilation inlet chamber 230. However, in other arrangements, the second end wall 236 may be formed by the intake duct 132, as described below.

With reference to FIGS. 5a and 5b, in other arrangements of the disclosure, the turbocharger compressor housing 220, e.g. the compressor housing portion 224, may comprise a wall portion 225 extending about the compressor inlet duct portion 226 and spaced apart, e.g. radially apart, from the compressor inlet duct portion 226. At least part of the crankcase ventilation inlet chamber 230 is formed between the wall portion 225 and the compressor inlet duct portion 226. The wall portion 225 of the compressor housing therefore forms at least part of the outer wall 238 of the inlet chamber 230.

As depicted, when the compressor housing 220 comprises the wall portion 225, the crankcase ventilation spigot 222 may be coupled to or integrally formed with the wall portion 225. The outlet opening 222b of the spigot 222 may be formed through the wall portion 225 into the crankcase ventilation inlet chamber 230. The spigot 222 may thereby be formed integrally with the compressor housing portion 224, and optionally the compressor inlet duct portion 226.

In the arrangement shown in FIG. 5b, the intake duct 132 comprises a chamber forming portion 133. The chamber forming portion 133 comprises a hollow, substantially cylindrical portion that extends about the compressor inlet duct portion 226 of the turbocharger compressor housing 220 when the intake duct 132 is coupled to the compressor inlet duct portion 226.

As depicted in FIG. 5b, the chamber forming portion 133 of the intake duct 132 may form part of the outer wall 238 of the crankcase ventilation inlet chamber 230. The chamber forming portion 133 and the wall portion 225 of the compressor housing 220 may together form the outer wall 238 of the inlet chamber 230. Additionally, the chamber forming portion 133 of the intake duct 132 may at least partially form the second end wall 236 of the inlet chamber 230.

In other arrangements, the wall portion 225 may form, e.g. entirely form, the outer wall 238 and the chamber forming portion 133 of the intake duct 132 may form the second end wall 236 of the inlet chamber. Alternatively, the wall portion 225 may form, e.g. entirely form, the outer wall 238 and the second end wall 236 of the inlet chamber 230.

The chamber forming portion 133 may be formed integrally with the intake duct 132. In some arrangements, the intake duct 132 may comprise a duct portion 132a and a connection portion 132b for connecting the duct portion to the compressor inlet duct portion 226. The connection portion 132b may be coupled to or formed integrally with the duct portion 132a. The chamber forming portion 133 may be formed by the connection portion 132b.

The arrangements shown in FIGS. 4b and 5b, the spigot 222 is spaced apart from the compressor housing portion 224, e.g. the part of the compressor housing portion forming the outlet volume 224a of the turbocharger compressor assembly 200, in other arrangements, a wall of the duct portion 222c of the spigot 222 may be in contact with or may be integrally formed with the compressor housing portion 224. In either arrangement, the spigot 222 may be formed from the same material as the compressor housing portion 224 and compressor inlet duct portion 226, e.g. from a metal material.

In either of the arrangements shown in FIGS. 4a and 4b, and FIGS. 5a and 5b, the crankcase ventilation inlet chamber 230 may be tuned to act as an intake resonator for damping vibrations of inlet gases within the intake duct 132 at the desired frequency. In particular, the size of the crankcase ventilation inlet chamber 230 and/or the size of the passage 240 may be selected in order to damp vibrations of the inlet gases at the desired frequency. The intake resonator 136 shown in FIG. 2 may therefore be omitted in arrangements of the engine assembly 100 comprising the compressor assembly 200 shown in FIGS. 4a and 4b or 5a and 5b.

In one example, the spigot 222 comprises a passage 240 through which crankcase gases may flow into an air intake passage toward a compressor inlet. The passage may be shaped via surfaces of each of the spigot and a compressor housing. A temperature of the surfaces of the compressor housing may be relatively high compared to surfaces of the spigot. As such, a temperature of gases flowing through the spigot and into the intake passage may be elevated relative to previous examples without auxiliary heating elements. The embodiment of the spigot of the present disclosure heats the crankcase gases via latent heat from the compressor with a reduced fuel penalty relative to the prior art illustrated in FIG. 1.

Crankcase gases enter the passage in a first direction, wherein the first direction is perpendicular to a direction of intake air flow through the intake passage. The crankcase gases may then turn and flow in a second direction, normal to the first direction, and opposite to the direction of intake air flow through the intake passage. The crankcase gases may then turn and again flow in the first direction as they exit the passage and enter the intake passage. By turning the crankcase gases within the passage, a duration of contact between the crankcase gases and the surfaces of the spigot and compressor housing may be increased, which may result in higher crankcase gas temperature, thereby decreasing a likelihood of water in the crankcase gases from freezing.

The duct may eject crankcase gases to an area of the intake passage proximal to the crankcase inlet. Relative to the prior art of FIG. 1, a distance between the outlet of the duct and the compressor inlet is reduced, thereby decreasing packaging constraints. The reduced distance is achieved via the one-piece manufacture of the compressor housing and the duct. Additionally or alternatively, the duct is integrally formed with the compressor housing such that surfaces of the passage are shaped via the compressor housing despite the duct and the compressor housing being distinct components.

In one example, a system comprises a crankcase ventilation duct arranged adjacent to a compressor inlet, wherein surfaces of a compressor housing shape a passage of the crankcase ventilation duct configured to direct crankcase gases to a portion of an inlet passage directly upstream of the compressor inlet relative to a direction of intake air flow. the crankcase ventilation duct and the compressor housing may be manufactured as a single piece. Additionally or alternatively, the crankcase ventilation duct is contiguous with the compressor housing and integrally formed therewith. The passage flows crankcase gases in a first direction before reaching a surface of the compressor housing portion, wherein the surface directs crankcase gases in a second direction perpendicular to the first direction, wherein the first direction is perpendicular to the direction of intake air flow.

In this way, a duct may be positioned adjacent to a compressor inlet, wherein surfaces of a compressor housing shape a portion of an outlet of the duct. The technical effect of utilizing compressor housing surfaces to shape portions of the duct is to increase a crankcase gas temperature. By doing this, water in the crankcase gases may not freeze. Furthermore, the shape of the duct may decrease a packaging size of the duct and compressor housing, while also decrease a material cost of the duct.

In another representation, a turbocharger compressor housing for a motor vehicle, the housing comprises a compressor housing portion for housing at least a portion of the turbocharger compressor, a compressor inlet duct portion for carrying a flow of inlet gases to an inlet of the turbocharger compressor, and a crankcase ventilation pipe in fluidic communication with the inlet of the turbocharger compressor, the pipe for the introduction of crankcase ventilation gases into the turbocharger compressor, wherein the pipe is integrally formed with the compressor housing portion.

A first example of the turbocharger compressor housing further comprises where the turbocharger compressor housing is a one-piece metal component.

A second example of the turbocharger compressor housing, optionally including the first example, further comprises where the crankcase ventilation pipe comprises an inlet opening, an outlet opening and a duct portion extending between the inlet opening and the outlet opening, wherein the duct portion is in contact with, or is integrally formed with the compressor housing portion.

A third example of the turbocharger compressor housing, optionally including one or more of the previous examples, further includes where the compressor housing portion at least partially defines an outlet flow passage of the turbocharger compressor.

A fourth example of the turbocharger compressor housing, optionally including one or more of the previous examples, further includes where the turbocharger compressor housing further comprises a crankcase ventilation inlet chamber extending about the compressor intake duct, wherein the crankcase ventilation inlet chamber is in fluidic communication with the inlet of the turbocharger compressor, and wherein the pipe is in fluidic communication with the crankcase ventilation inlet chamber.

A fifth example of the turbocharger compressor housing, optionally including one or more of the previous examples, further includes where at least a portion of a wall of the crankcase ventilation inlet chamber is formed by the compressor intake duct and/or the compressor housing portion.

A sixth example of the turbocharger compressor housing, optionally including one or more of the previous examples, further includes where a passage is formed between the crankcase ventilation inlet chamber and the compressor intake duct or the compressor housing portion, wherein an opening of the passage into the crankcase ventilation inlet chamber is spaced apart from an opening of the pipe into the crankcase ventilation inlet chamber along a wall of the of the crankcase ventilation inlet chamber formed by the compressor intake duct and/or the compressor housing portion.

A seventh example of the turbocharger compressor housing, optionally including one or more of the previous examples, further includes where the turbocharger compressor housing further comprises a wall portion extending at least partially about the compressor inlet duct portion, wherein an outer wall of the crankcase ventilation inlet chamber is at least partially formed by the wall portion.

An eighth example of the turbocharger compressor housing, optionally including one or more of the previous examples, further includes where the wall portion is integrally formed with the compressor housing portion.

A ninth example of the turbocharger compressor housing, optionally including one or more of the previous examples, further includes where the crankcase ventilation inlet chamber is configured to damp pressure variation in the inlet air arriving at the compressor inlet duct portion.

An example comprising where the turbocharger compressor housing of the previous examples is arranged in an intake assembly comprising an intake duct in fluidic communication with the compressor inlet duct portion.

A tenth example of the turbocharger compressor housing, optionally including one or more of the previous examples, further includes where a wall of the crankcase ventilation inlet chamber is at least partially formed by the intake duct.

An eleventh example of the turbocharger compressor housing, optionally including one or more of the previous examples, further includes where an axial end wall of the crankcase ventilation inlet chamber is at least partially formed by the intake duct.

A twelfth example of the turbocharger compressor housing, optionally including one or more of the previous examples, further includes where at least a portion of an outer wall of the crankcase ventilation inlet chamber is formed by the intake duct.

It will be appreciated by those skilled in the art that although the invention has been described by way of example, with reference to one or more exemplary examples, it is not limited to the disclosed examples and that alternative examples could be constructed without departing from the scope of the invention as defined by the appended claims.

Note that the example control and estimation routines included herein can be used with various engine and/or vehicle system configurations. The control methods and routines disclosed herein may be stored as executable instructions in non-transitory memory and may be carried out by the control system including the controller in combination with the various sensors, actuators, and other engine hardware. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated actions, operations and/or functions may be repeatedly performed depending on the particular strategy being used. Further, the described actions, operations and/or functions may graphically represent code to be programmed into non-transitory memory of the computer readable storage medium in the engine control system, where the described actions are carried out by executing the instructions in a system including the various engine hardware components in combination with the electronic controller.

It will be appreciated that the configurations and routines disclosed herein are exemplary in nature, and that these specific embodiments are not to be considered in a limiting sense, because numerous variations are possible. For example, the above technology can be applied to V-6, I-4, I-6, V-12, opposed 4, and other engine types. The subject matter of the present disclosure includes all novel and non-obvious combinations and sub-combinations of the various systems and configurations, and other features, functions, and/or properties disclosed herein.

As used herein, the term “approximately” is construed to mean plus or minus five percent of the range unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A turbocharger compressor housing for a motor vehicle, the housing comprising:
a compressor housing portion for housing at least a portion of the turbocharger compressor;
a compressor inlet duct portion configured to direct a flow of inlet gases to an inlet of the turbocharger compressor; and
a crankcase ventilation pipe in fluidic communication with the inlet of the turbocharger compressor and configured to direct crankcase ventilation gases into the turbocharger compressor, wherein the pipe is integrally formed with the compressor housing portion.

2. The turbocharger compressor housing of claim 1, wherein the turbocharger compressor housing is a one-piece metal component.

3. The turbocharger compressor housing of claim 1, wherein the crankcase ventilation pipe comprises an inlet opening, an outlet opening, and a duct portion extending between the inlet opening and the outlet opening, wherein the duct portion is at least partially shaped via surfaces of the compressor housing portion.

4. The turbocharger compressor housing of claim 1, wherein the compressor housing portion at least partially defines an outlet flow passage of the turbocharger compressor.

5. The turbocharger compressor housing of claim 1, wherein the turbocharger compressor housing further comprises:
a crankcase ventilation inlet chamber extending about a compressor intake duct, wherein the crankcase ventilation inlet chamber is in fluidic communication with the inlet of the turbocharger compressor, and wherein the pipe is in fluidic communication with the crankcase ventilation inlet chamber.

6. The turbocharger compressor housing according to claim 5, wherein at least a portion of a wall of the crankcase ventilation inlet chamber is formed by the compressor intake duct and/or the compressor housing portion.

7. The turbocharger compressor housing of claim 6, wherein a passage is formed between the crankcase ventilation inlet chamber and the compressor intake duct or the compressor housing portion, wherein an opening of the passage into the crankcase ventilation inlet chamber is spaced apart from an opening of the pipe into the crankcase ventilation inlet chamber along a wall of the of the crankcase ventilation inlet chamber formed by the compressor intake duct and/or the compressor housing portion.

8. The turbocharger compressor housing of claim 7, wherein the turbocharger compressor housing further comprises a wall portion extending at least partially about the compressor inlet duct portion, wherein an outer wall of the crankcase ventilation inlet chamber is at least partially formed by the wall portion.

9. The turbocharger compressor housing according to claim 8, wherein the wall portion is integrally formed with the compressor housing portion.

10. The turbocharger compressor housing of claim 9 wherein the crankcase ventilation inlet chamber is configured to damp pressure variation in the inlet air arriving at the compressor inlet duct portion.

11. The turbocharger compressor housing of claim 5, wherein the compressor housing portion is arranged in an intake assembly comprising an intake duct in fluidic communication with the compressor inlet duct portion.

12. The turbocharger compressor housing of claim 11, wherein a wall of the crankcase ventilation inlet chamber is at least partially formed by the intake duct.

13. The turbocharger compressor housing of claim 12, wherein an axial end wall of the crankcase ventilation inlet chamber is at least partially formed by the intake duct.

14. The turbocharger compressor housing of claim 12, wherein at least a portion of an outer wall of the crankcase ventilation inlet chamber is formed by the intake duct.

15. A system, comprising:
a crankcase ventilation duct arranged adjacent to a compressor inlet, wherein surfaces of a compressor housing shape a passage of the crankcase ventilation duct configured to direct crankcase gases to a portion of an inlet passage directly upstream of the compressor inlet relative to a direction of intake air flow.

16. The system of claim 15, wherein the crankcase ventilation duct and the compressor housing are manufactured as a single piece.

17. The system of claim 15, wherein the crankcase ventilation duct is contiguous with the compressor housing and integrally formed therewith.

18. The system of claim 15, wherein the passage flows crankcase gases in a first direction before reaching a surface of the compressor housing portion, wherein the surface directs crankcase gases in a second direction perpendicular to the first direction, wherein the first direction is perpendicular to the direction of intake air flow.

19. A engine system, comprising:
a compressor housing and a crankcase ventilation duct formed as a single-piece; wherein a passage configured to flow crankcase gases from a crankcase to a portion of an intake passage directly upstream of a compressor inlet is configured to flow crankcase gases in a first direction perpendicular to a direction of intake air flow in the intake passage and in a second direction opposite the direction of intake air flow.

20. The engine system of claim 19, wherein the compressor housing and the crankcase ventilation duct comprise an identical material.
